(19) United States
(12) Patent Application Publication
(10) Pub. No.: US 2026/0030860 A1
(43) Pub. Date: Jan. 29, 2026

(54) METHODS AND SYSTEMS FOR MAPPING OBJECTS

(71) Applicant: Donewell Data Pty Ltd, Agnes Water (AU)

(72) Inventor: Darren Jay Andrews, Agnes Water (AU)

(73) Assignee: Donewell Data Pty Ltd, Agnes Water, QL (AU)

(21) Appl. No.: 19/117,897

(22) PCT Filed: Sep. 22, 2023
(86) PCT No.: PCT/AU2023/050921

§ 371 Date: Apr. 2, 2025

(30) Foreign Application Priority Data
Oct. 7, 2022 (AU) 2022902935

(51) Int. Cl. G06V 10/25; G06T 7/11; G06T 7/12; G06V 10/764

(52) U.S. Cl. CPC G06V 10/25; G06T 7/11; G06T 7/12; G06V 10/764

(57) ABSTRACT

Disclosed herein are methods and systems for mapping objects. A computer-implemented method for mapping objects comprises receiving image data of an area, and applying an image segmentation process to the image data to identify one or more elements of the image data determined to have a likelihood of representing one or more predetermined objects in the area. The method further comprises assigning a value to each element of the image data based on the determined likelihood of the element representing the one or more predetermined objects, partitioning the image data into two or more overlapping layers of regions, determining a quality of fit of one or more regions of each layer of the two or more layers to each of the one or more predetermined objects using the values assigned to the elements of the image data, and forming one or more bounding regions from one or more regions of one or more layers of the two or more layers based on the quality of fit of the respective one or more regions. Each bounding region encloses one or more of the one or more predetermined objects. The method further comprises outputting region data representing the one or more bounding regions. Also disclosed here are methods and systems for detecting changes in objects.

### TECHNICAL FIELD

The present invention relates to methods and systems for mapping objects. In further specific examples, the present invention relates to methods and systems for mapping plants. The present invention further relates to methods and systems for detecting changes in objects.

### BACKGROUND

Agricultural fields, crops, and plants require the application of various chemicals, such as herbicides, pesticides, fungicides, and fertilisers. Traditionally, these chemicals have been applied in a “broad acre” or “blanket” fashion, in which the chemicals are sprayed evenly across the whole field or plant. Recent developments, however, have enabled chemicals to be applied in a more selective way.

One such development involves the use of agricultural sprayers mounted with cameras to detect targets. For example, the sprayer might be automatically activated when its camera unit detects the colour green, indicative of a plant. A downside of such camera-mounted sprayers is that the effectiveness and accuracy of the sprayer is limited by the speed at which it is moving. Lighting conditions also affect the operation of such sprayers, reducing their ability to operate during twilight or at night, which is an issue because the application of many chemicals is most effective at these times, when temperatures are lower than during daylight hours.

Geoprocessing tools have also been used to analyse agricultural fields, crops, and plants to guide the targeted application of chemicals. Such techniques typically rely on raster analysis, in which a grid divides a map of the field into square sections, and the sections are then analysed. It is difficult, however, for the grid subdivisions to account for extraneous objects in the field, such as roads, railway tracks, or tramlines. In order to exclude extraneous objects from the analysis, the objects must first be identified, the map rotated to align the objects with the grid boundaries, and the image clipped, cropped, or otherwise processed. This is a time-consuming and computationally intensive process.

It is desired to address or ameliorate one or more disadvantages or limitations associated with the prior art, or to at least provide a useful alternative.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

### SUMMARY

According to an example aspect, there is provided a method for mapping objects. The method comprises: receiving image data of an area; applying an image segmentation process to the image data to identify one or more elements of the image data determined to have a likelihood of representing one or more predetermined objects in the area; assigning a value to each element of the image data based on the determined likelihood of the element representing the one or more predetermined objects; partitioning the image data into a plurality of regions and determining, for each of the one or more predetermined objects, one or more regions of the plurality of regions fitting the predetermined object; categorising, for each of the one or more predetermined objects, the one or more regions fitting the predetermined object into one of a plurality of classes based on the values assigned to the elements of the image data representing the predetermined object; and outputting the categorised regions.

In certain embodiments, partitioning the image data into the plurality of regions comprises successively partitioning the image data into a layer of a sequence of two or more layers of regions and, for each layer in the sequence, determining a quality of fit of the regions of the layer to the one or more predetermined objects, wherein the image data is partitioned into a next layer in the sequence upon determining that the fit of the regions of a current layer in the sequence to one of the one or more predetermined objects does not meet one or more fit criteria. In certain embodiments, the image data is partitioned into the next layer in the sequence upon determining that the fit of the regions of the current layer in combination with regions of one or more preceding layers in the sequence to one of the one or more predetermined objects does not meet the one or more fit criteria. In certain embodiments, the one or more fit criteria comprise a criterion that the elements of the image data representing the predetermined object fill at least a minimum portion of each region of the current layer that contains at least one of the elements of the image data representing the predetermined object. In certain embodiments, the one or more fit criteria comprise a criterion that the elements of the image data representing the predetermined object do not extend into a gap between regions of the current layer that is not contained in one or more regions of a previous layer. In certain embodiments, each successive layer of regions in the sequence overlaps the preceding layers of regions in the sequence. In certain embodiments, the regions in each layer of regions are arranged in an array.

In certain embodiments, the sequence of layers comprises a previous layer of regions and a successive layer of regions following the previous layer in the sequence, wherein the regions of the successive layer are offset relative to the regions of the previous layer. In certain embodiments, the sequence of layers comprises a previous layer of regions and a successive layer of regions following the previous layer in the sequence, wherein the regions of the successive layer have a different size than the regions of the previous layer. In certain embodiments, the sequence of layers comprises a previous layer of regions and a successive layer of regions following the previous layer in the sequence, wherein the regions of the successive layer have different shapes than the regions of the previous layer.

In certain embodiments, the regions have the shape of polygons with six or more sides. In certain embodiments, the regions are hexagonal regions. In certain embodiments, the regions have non-tessellating shapes. In certain embodiments, the regions are octagonal regions.

In certain embodiments, the method further comprises: identifying one or more unoccupied regions, wherein an unoccupied region is a region of the plurality of regions for which a quantity representing the values assigned to the elements of the image data contained in the region is below a minimum threshold value; and categorising the one or more unoccupied regions into one of the plurality of classes.

In certain embodiments, the method further comprises aggregating adjacent or overlapping regions that are categorised in the same class into a single region prior to outputting the categorised regions. In certain embodiments, the adjacent or overlapping regions are regions in two or more different layers of regions.

In certain embodiments, the method further comprises enlarging the regions fitting one or more of the predetermined objects. In certain embodiments, the method further comprises: receiving elevation data of the area; and enlarging the regions fitting one or more of the predetermined objects where an elevation variation exceeds an elevation variation threshold based on the elevation data.

In certain embodiments, for each of the one or more predetermined objects, the one or more regions fitting the predetermined object are categorised into classes based on one or more physical attributes of the predetermined object. In certain embodiments, the physical attribute is one of size, height, shape, and colour. In certain embodiments, each region is categorised into one of two or more classes, comprising one class for regions containing no elements of the image data representing the one or more predetermined objects, and one or more classes for different size ranges of the one or more predetermined objects fitted by the regions. In certain embodiments, for each of the one or more predetermined objects, the one or more regions fitting the predetermined object are categorised into classes based on one or more chemical attributes of the predetermined object.

In certain embodiments, a first value is assigned to each element of the image data determined to have a likelihood of representing the one or more predetermined objects, and a second value is assigned to each element of the image data determined to have a likelihood of not representing the one or more predetermined objects, wherein the first and second values are different. In certain embodiments, each region is categorised into one of the classes based on the sum of the values assigned to the elements of the image data representing the predetermined object fitted by the region.

In certain embodiments, the image segmentation process is trained by using at least one of: image data of the predetermined objects; image data not representing the predetermined objects; and image data of area surrounding the predetermined objects.

In certain embodiments, the method further comprises assigning geographical coordinates to the elements of the image data corresponding to the geographical coordinates of the locations of the area represented by the elements of the image data.

In certain embodiments, the method further comprises outputting an action parameter for each region based on the class of the respective region. In certain embodiments, the method further comprises providing the regions and the action parameter for each region to an apparatus configured to affect the locations of the area represented by each region based on the corresponding action parameter for that region.

In certain embodiments, the image data of the area comprises one or more aerial images of the area.

According to another example aspect, there is provided a system for mapping objects. The system comprises at least one processing system configured to: receive image data of an area; apply an image segmentation process to the image data to identify one or more elements of the image data determined to have a likelihood of representing one or more predetermined objects in the area; assign a value to each element of the image data based on the determined likelihood of the element representing the one or more predetermined objects; partition the image data into a plurality of regions and determine, for each of the one or more predetermined objects, one or more regions of the plurality of regions fitting the predetermined object; categorise, for each of the one or more predetermined objects, the one or more regions fitting the predetermined object into one of a plurality of classes based on the values assigned to the elements of the image data representing the predetermined object; and output the categorised regions.

In certain embodiments, the at least one processing system is further configured to output an action parameter for each region based on the class of the respective region. In certain embodiments, the system further comprises an apparatus configured to receive the regions and the action parameter for each region, and to affect the locations of the area represented by each region based on the corresponding action parameter for that region.

In certain embodiments, the one or more predetermined objects are plants, the area is an agricultural field, the action parameter is an application rate for a product, and the apparatus is an agricultural sprayer configured to spray the product with an adjustable spray rate.

According to another example aspect, there is provided a computer-implemented method for mapping objects. The method comprises: receiving image data of an area; applying an image segmentation process to the image data to identify one or more elements of the image data determined to have a likelihood of representing one or more predetermined objects in the area; assigning a value to each element of the image data based on the determined likelihood of the element representing the one or more predetermined objects; partitioning the image data into two or more overlapping layers of regions; determining a quality of fit of one or more regions of each layer of the two or more layers to each of the one or more predetermined objects using the values assigned to the elements of the image data; forming one or more bounding regions from one or more regions of one or more layers of the two or more layers based on the quality of fit of the respective one or more regions, wherein each bounding region encloses one or more of the one or more predetermined objects; and outputting region data representing the one or more bounding regions.

In certain embodiments, partitioning the image data comprises sequentially partitioning the image data into each layer of the two or more layers of regions until the quality of fit of one or more regions of the layers partitioning the image data to each of the one or more predetermined objects meets one or more fit criteria. In certain embodiments, the one or more fit criteria comprise a criterion that the elements of the image data representing the predetermined object fill at least a minimum portion of each region of at least one layer of the two or more layers that contains at least one of the elements of the image data representing the predetermined object.

In certain embodiments, the one or more fit criteria comprise a criterion that the elements of the image data representing the predetermined object do not extend into a gap between regions of at least one layer of the two or more layers that is not contained in one or more regions of another layer of the two or more layers. In certain embodiments, determining a quality of fit comprises determining that elements of the image data representing one of the one or more predetermined objects are contained within a gap of a first layer of the two or more layers, and wherein the bounding region enclosing the respective predetermined object is formed from a region of a second layer of the two or more layers that encloses the respective gap of the first layer.

In certain embodiments, the regions of each layer of the two or more layers differ from the regions of other layers of the two or more layers in at least one of shape, size, and offset.

In certain embodiments, the regions of each layer of the two or more layers are arranged in an array and have non-tessellating shapes. In certain embodiments, the two or more layers comprise one or more pairs of layers, wherein the regions of the layers in each pair are offset such that the regions of a first layer of the pair enclose gaps between regions of a second layer of the pair, and wherein partitioning the image data comprises sequentially partitioning the image data into each pair of the one or more pairs of layers of regions until the quality of fit of one or more regions of the layers partitioning the image data to each of the one or more predetermined objects meets one or more fit criteria.

In certain embodiments, the regions of at least one of the two or more layers have the shape of regular polygons with six or more sides.

In certain embodiments, the method further comprises categorising each of the one or more bounding regions into one of a plurality of classes based on characteristics of the one or more predetermined objects enclosed by the respective bounding region. In certain embodiments, the method further comprises: identifying one or more unoccupied regions, being regions of the two or more layers for which a quantity representing the values assigned to the elements of the image data contained therein is below a minimum threshold value; and categorising the one or more unoccupied regions into one of the plurality of classes. In certain embodiments, the method further comprises aggregating adjacent or overlapping bounding regions that are categorised in the same class into a single region prior to outputting the region data. In certain embodiments, the characteristics are one or more of size, height, shape, colour, and chemical characteristics. In certain embodiments, each bounding region is categorised into one of the classes based on the sum of the values assigned to the elements of the image data representing the one or more predetermined objects enclosed by the bounding region.

In certain embodiments, the method further comprises outputting an action parameter for each bounding region based on the class of the respective bounding region. In certain embodiments, the method further comprises providing the region data and the action parameter for each bounding region to an apparatus configured to affect the locations of the area represented by each bounding region based on the corresponding action parameter for that bounding region.

In certain embodiments, the method further comprises enlarging one or more of the bounding regions to provide a buffer zone around the one or more predetermined objects enclosed therein. In certain embodiments, the enlarged bounding regions are enlarged based on elevation data of the area.

In certain embodiments, the image segmentation process is trained by using at least one of: image data of the predetermined objects; image data not representing the predetermined objects; and image data of areas surrounding the predetermined objects. In certain embodiments, the method further comprises assigning geographical coordinates to the elements of the image data corresponding to the geographical coordinates of the locations of the area represented by the elements of the image data.

According to another example aspect, there is provided a system for mapping objects. The system comprises at least one processing system configured to: receive image data of an area; apply an image segmentation process to the image data to identify one or more elements of the image data determined to have a likelihood of representing one or more predetermined objects in the area; assign a value to each element of the image data based on the determined likelihood of the element representing the one or more predetermined objects; partition the image data into two or more overlapping layers of regions; determine a quality of fit of one or more regions of each layer of the two or more layers to each of the one or more predetermined objects using the values assigned to the elements of the image data; form one or more bounding regions from one or more regions of one or more layers of the two or more layers based on the quality of fit of the respective one or more regions, wherein each bounding region encloses one or more of the one or more predetermined objects; and output region data representing the one or more bounding regions.

In certain embodiments, the at least one processing system is further configured to: categorise each of the one or more bounding regions into one of a plurality of classes based on characteristics of the one or more predetermined objects enclosed by the respective bounding region; and output an action parameter for each bounding region based on the class of the respective bounding region. In certain embodiments, the system further comprises an apparatus configured to receive the region data and the action parameter for each bounding region, and to affect the locations of the area represented by each bounding region based on the corresponding action parameter for that bounding region.

According to another example aspect, there is provided a computer-implemented method for detecting changes in objects. The method comprises: receiving initial image data of an area; generating initial bounding regions enclosing one or more predetermined objects in the area represented by the initial image data, wherein the initial bounding regions are categorised into classes based on the predetermined objects enclosed by the initial bounding regions; receiving subsequent image data of the area, wherein the subsequent image data represents the area at a later time than the initial image data; generating subsequent bounding regions enclosing one or more predetermined objects in the area represented by the subsequent image data, wherein the subsequent bounding regions are categorised into the classes based on the predetermined objects enclosed by the subsequent bounding regions; and comparing the subsequent bounding regions of each class to the initial bounding regions of the same class. The initial bounding regions and the subsequent bounding regions are generated by applying a method for mapping objects described above to the initial image data and to the subsequent image data, respectively.

In certain embodiments, comparing the subsequent bounding regions of each class to the initial bounding regions for the same class comprises: determining the locations of the area represented by the initial bounding regions and by the subsequent bounding regions that are categorised in different classes; determining, for each class, an increase in the coverage of the subsequent bounding regions relative to the initial bounding regions in the same class; and determining, for each class, a decrease in the coverage of the subsequent bounding regions relative to the initial bounding regions in the same class.

In certain embodiments, the initial image data represents the area before a treatment performed in the area, and the subsequent image data represents the area after the treatment. In certain embodiments, the method further comprising performing an initial treatment in the area based on the initial bounding regions. In certain embodiments, the method further comprises performing a subsequent treatment in the area based on the subsequent bounding regions.

In certain embodiments, each initial or subsequent bounding region is assigned an action parameter based on the class of the region, and performing the initial treatment or the subsequent treatment comprises providing data representing the initial or subsequent bounding regions and the associated action parameters to an apparatus configured to perform an action in the locations of the area represented by the initial or subsequent bounding regions based on the associated action parameters.

In certain embodiments, the initial image data comprises initial image data of the area at a first resolution and initial image data of at least part of the area at a second resolution, wherein the subsequent image data comprises subsequent image data of the area at the first resolution and subsequent image data of at least part of the area at the second resolution, wherein the second resolution is higher than the first resolution.

According to another example aspect, there is provided a system for detecting changes in objects. The system comprises at least one processing system configured to: receive initial image data of an area; generate initial bounding regions enclosing one or more predetermined objects in the area represented by the initial image data, wherein the initial bounding regions are categorised into classes based on the predetermined objects enclosed by the initial bounding regions; receive subsequent image data of the area, wherein the subsequent image data represents the area at a later time than the initial image data; generate subsequent bounding regions enclosing one or more predetermined objects in the area represented by the subsequent image data, wherein the subsequent bounding regions are categorised into the classes based on the predetermined objects enclosed by the subsequent regions; and compare the subsequent bounding regions of each class to the initial bounding regions of the same class. The at least one processing system is configured to generate the initial bounding regions and the subsequent bounding regions by applying a method for mapping objects described above to the initial image data and to the subsequent image data, respectively.

### BRIEF DESCRIPTION OF THE DRAWINGS

Some embodiments of the present invention are described below, by way of example only, with reference to the accompanying drawings, in which:

FIG. 1 shows a flowchart of an example method for mapping objects;

FIG. 2 shows example image data of an area containing multiple objects;

FIG. 3 shows the image data of FIG. 2 partitioned into an example first layer of regions;

FIG. 4 shows the image data of FIG. 2 partitioned into an example second layer of regions;

FIG. 5 shows the image data of FIG. 2 and example bounding regions formed from the regions of the first and second layers;

FIG. 6 shows the image data of FIG. 2 partitioned into an example third layer of regions;

FIG. 7 shows the image data of FIG. 2 and example bounding regions formed from the regions of the first, second, and third layers;

FIG. 8 shows the image data of FIG. 2 and example expanded bounding regions;

FIG. 9 shows other example image data of an area marked with hexagonal regions;

FIG. 10 shows an example map including a complex region formed by aggregating octagonal regions and an unoccupied area;

FIG. 11 shows the map of FIG. 10, in which the complex region has been marked for an action;

FIG. 12 shows the map of FIG. 10, in which the unoccupied area has been marked for an action;

FIG. 13 shows other example image data of an area containing multiple objects, including example compound bounding regions;

FIG. 14 shows a block diagram of an example system for mapping objects; and

FIG. 15 shows a flowchart of an example method for detecting changes in objects.

### DETAILED DESCRIPTION

Embodiments of the invention provide methods and systems for detecting and/or mapping the locations of objects in an area. Embodiments of the invention further provide methods and systems for detecting or monitoring changes in objects or of conditions of the objects in an area over time. In some examples, embodiments of the invention make use of machine learning to identify, analyse, and measure variations of objects within an agricultural field. Embodiments of the invention may be used to generate geographically accurate maps which can be used to control machinery in coordination with user inputs or autonomously.

An object may be any tangible thing or matter, organic or inorganic, natural or artificial, unitary (i.e. formed by a single entity) or composite (i.e. formed by several parts or elements), having any size and shape. In some examples, the objects are plants, such as weeds, crops, or trees. In other examples, the objects are fungi or mould. In other examples, the objects are any objects in a predefined state or condition, such as objects or structures that are corroded, damaged, or coated with paint.

An area may be any kind of physical space or environment containing any object. In some examples, the area is an area of land, such as an agricultural field for cultivating one or more crops.

The methods and systems described herein may process image data of the area. The image data may comprise one or more images of the area obtained by one or more imaging devices, such as one or more cameras, magnetic field sensors, or other sensors. In some examples, the one or more images comprise aerial images, such as images captured from an elevated platform, including an unmanned aerial vehicle (UAV), an aircraft, or a satellite, showing a top view of the area. In some examples, the one or more images comprise orthophotos or orthoimages. In other examples, the one or more images comprise any kind of image showing any kind of view of the area. For example, in agricultural contexts, the images may include both aerial images to provide a view of one or more fields and images captured at ground level (e.g. close-up or macro images) to provide a view of individual objects in the field for analysing early seed strikes or chlorosis in plants or leaves. The image data may be produced using any part of the electromagnetic spectrum, such as visible, ultraviolet, or near-infrared light. In some examples, the image data represents a magnetic field or an electric field.

Although the examples provided herein generally relate to the field of agriculture, it is to be understood that the described methods and systems can also be applied to any other field, including asset inspection and fault detection, such as for detecting areas of mould, corrosion, or damage.

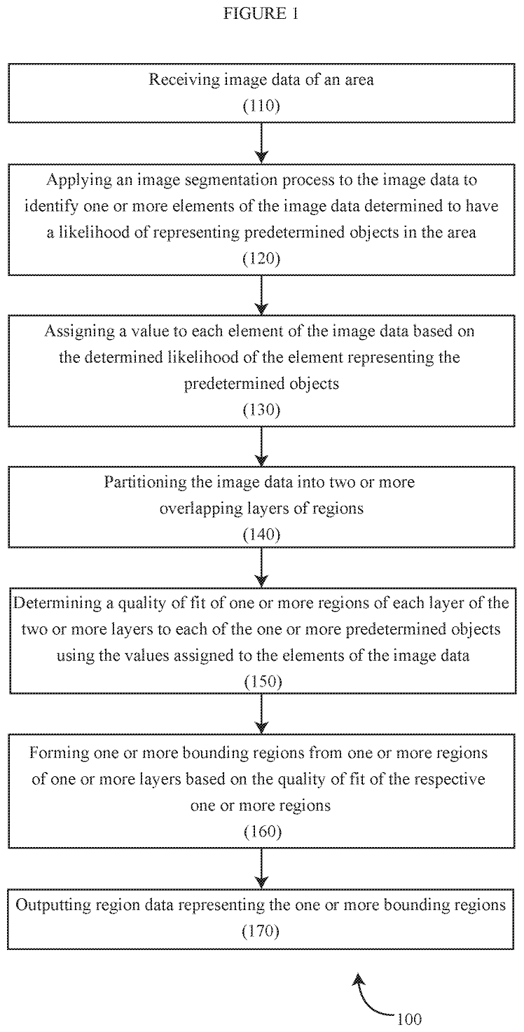

FIG. 1 shows a flowchart of an example method 100 for mapping objects. Method 100 may be a computer-implemented method, executed by one or more processing systems.

Step 110 of method 100 comprises receiving or obtaining image data of an area. Other data of the area may also be received or obtained, including non-image data. The data of the area may include image data and non-image data such as geospatial data, camera angles, elevation above sea level, and pressure data of the area. The non-image data of the area, including any metadata, may be linked or associated to the image data, for example, using tags according to the exchangeable file format (Exif).

Step 120 of method 100 comprises applying an image segmentation process to the image data to identify or detect one or more elements of the image data determined to have a likelihood or confidence of representing one or more predetermined or target objects located in the area. In some examples, two or more image segmentation processes may be applied to the image data for detecting two or more different kinds of objects, such as weeds and crops.

In some examples, the image segmentation process is implemented by pixel-based classification. In other examples, the image segmentation process is implemented by a convolutional neural network. In other examples, the image segmentation process is implemented by a combination of a convolutional neural network and pixel-based classification. In other examples, the image segmentation process is implemented by any machine learning or deep learning model, such as a fully convolutional neural network, a region-based segmentation process, a mathematical morphology segmentation, a genetic algorithm-based segmentation, an artificial neural network-based segmentation, a deep learning structure, or a combination of these.

An element of the image data may be any component of the image data, such as a pixel, a cluster of pixels, or a group of pixels.

The image segmentation process may be created or trained by using image data of the predetermined objects, image data not showing the predetermined objects, and/or image data of an area near or surrounding the predetermined objects. For example, in agricultural contexts, the training data may include images of plants, images of the soil surrounding the plants, and/or images of an area devoid of plants. The image data used for training may be georeferenced image data, and it may be labelled or marked, for example, by a user or by semi-supervised learning. In some examples, to expand the training set, additional or artificial image data is generated through image augmentation, by applying transformations or image processing functions to the original image data.

Training the image segmentation process with images of an area (e.g. soil) near or surrounding the predetermined objects (e.g. a plant) may enable it to recognise pixel patterns which are likely to precede or indicate the appearance of an object, providing an additional benchmark for detecting the predetermined objects that allows more false positives to be filtered out. In agricultural contexts, this kind of training data may be useful when detecting weeds that have not been successfully killed in a previous herbicide application, so that the exterior of the weed may be brown but the inner parts of the weed are still green.

Step 130 of method 100 comprises assigning a value or weight to each element of the image data based on the determined likelihood or confidence of the element representing the one or more predetermined objects. The value may be assigned by the image segmentation process or by another process or function based on the output of the image segmentation process.

In some examples, such as when the image segmentation process uses pixel-based classification, a first value (e.g. a value of 1) is assigned to each element whose likelihood of representing the predetermined objects is greater than a likelihood threshold, and a second value (e.g. a value of 0) different from the first value is assigned to each element whose likelihood of representing the predetermined objects is less than the likelihood threshold. The likelihood threshold may be adjusted to control the sensitivity of object detection. In other examples, such as when the image segmentation process is implemented by a convolutional neural network, each element of the image data may be assigned any value in a predefined range, such as between 0 and 1, based on the determined likelihood or confidence of the element representing the one or more predetermined objects.

In some examples, method 100 further comprises a step of assigning geographical coordinates to the elements of the image data corresponding to the geographical coordinates of the locations of the area represented by the elements of the image data, so that the image data becomes georeferenced image data.

Step 140 of method 100 comprises partitioning or dividing the image data into a plurality of overlapping or coincident layers or sets of regions, tiles, or sections. The partitioning is a spatial partitioning, based on the spatial position or coordinates of the elements of the image data. Any two layers or sets of regions may be considered to overlap if they extend over the same part or area of the image data. In some examples, two layers or sets of regions overlap if at least one region of one layer encloses at least part of an area enclosed by at least one region of the other layer. In some examples, two layers or sets of regions overlap if an edge of at least one region of one layer intersects an edge of at least one region of the other layer.

The partitioning may comprise overlaying, superimposing, or tessellating the image data with the regions, represented by shapes and lines. The regions of each layer may be disposed in any arrangement. In some examples, each region of a layer does not overlap any other region in the same layer. In some examples, the regions of a layer are disposed in an ordered or uniform arrangement or formation, such as an array, matrix, or any other repeating pattern. In some examples, the regions of a layer are disposed in a contiguous arrangement, so that adjacent regions of the same layer share a common border or side.

The regions may have any shape, regular or irregular. The regions of a layer or of different layers may have the same shape or different shapes. In some examples, the regions are hexagonal regions. In other examples, the regions are octagonal regions. In other examples, the regions are in the shape of a regular polygon with six or more, seven or more, or eight or more sides.

Polygons such as hexagons and octagons may be more likely to self-align to the curvature of the earth and to features present in the area, such as railway tracks and contour banks, than simpler polygons like triangles and squares. A polygon's suitability to align with or match objects having complex shapes, such as plants or leaves, may improve as the number of its sides increases. For example, hexagonal or octagonal regions may be better than square regions at containing roughly circular or curved objects, such as plants, reducing the possibility that such objects may be incorrectly analysed. Moreover, since the computational complexity of manipulating a polygon at the machine level (for example, when drawing, measuring, or displaying the polygon, or when retrieving data defining the polygon) increases as the number of its sides increases, hexagonal or octagonal regions may require fewer computational resources than circular regions. Octagonal regions may generally provide a better fit than hexagonal regions when trying to detect objects such as plants, but hexagonal regions may result in files with smaller sizes, which are faster to load than those of octagonal regions.

Step 150 of method 100 comprises determining a quality or closeness of fit of one or more regions of each layer of regions to each predetermined object.

Steps 130 and 140 may be performed alternately, so that after the image data is partitioned into a layer of regions, the quality of fit of the regions of that layer is checked before partitioning the image data into another layer of regions. Therefore, the image data may be successively or sequentially partitioned into a sequence of two, three, or more layers of regions, until a desired fit is achieved, meeting one or more fit criteria, or until the image data has been partitioned into a preset number of layers. If a desired fit has not been achieved for one or more objects within the current or any previous layer, subsequent varied layers are added to achieve a desired fit for the objects yet to achieve a desired fit. Each successive layer in the sequence may be applied to the whole image data or to part of the image data containing objects for which a desired fit has not been achieved, so that, in some examples, only part of the image data is partitioned into a one or more layers of the sequence of layers.

The quality of fit may be defined by one or more fit criteria. An example of a fit criterion used to assess the quality of the fit provided by the regions is the criterion that the elements of the image data representing a detected object fill at least a minimum area or portion, such as 60 percent, of each region of the current layer (in some examples in combination with each region of the preceding layers) that contains at least one of the elements of the image data representing the detected object. Another example criterion is that the elements of the image data representing a detected object do not extend into a gap between regions of the current layer that is not contained in one or more regions of a previous layer. Another example criterion is that the elements of the image data representing a detected object do not extend into a gap between a region of the current (or preceding) layer that contains at least one of the elements of the image data representing the detected object and a region of the current (or preceding) layer that contains no elements of the image data representing the detected object, so that all the elements of the image data representing a perimeter of the object are located within regions.

In order to vary the fit, the regions of one or more layers of the sequence may have different characteristics relative to the regions of other layers in the sequence. In some examples, the regions of one layer may be offset or displaced relative to the regions of other layers in the sequence. In some examples, the regions of one layer of the sequence may have a different size, such as by being smaller or larger, than the regions of preceding layers in the sequence. For example, the size of the regions in successive layers of the sequence may be increased until the edge of an object is detected and the whole object is contained in a single region. Alternatively, the size of the regions in successive layers of the sequence may be decreased to provide a closer fit of the regions to the boundary of an object. In some examples, the regions of one layer of the sequence may have different shapes than the regions of other layers in the sequence. In some examples, the regions of any layer in the sequence may differ from the regions of any other layer in the sequence in one or more of offset, size, and shape.

Step 160 of method 100 comprises forming or determining one or more bounding regions from one or more regions of the layers of regions based on the quality of fit of the respective one or more regions. Each bounding region contains, encloses, or confines one or more of the predetermined objects.

In some examples, a bounding region comprises two or more regions from one or more layers. For example, a bounding region may be formed by aggregating or joining two or more regions of one or more layers fitted to the same predetermined object, so that the two or more regions dissolve into a single or composite bounding region. Two or more regions forming a bounding region may also remain distinct after the bounding region is formed, so that the bounding region is formed by selecting two or more regions of one or more layers without aggregating them. In other examples, a bounding region comprises a single, or no more than one, region from any one of the layers.

Therefore, a bounding region may correspond or be equivalent to one or more regions from one or more layers. The difference between a region and a bounding region is that a bounding region corresponds to those regions that have been determined to appropriately fit or enclose one or more objects.

Step 170 of method 100 comprises outputting region data representing or indicative of the one or more bounding regions. In some examples, outputting the region data comprises generating a map of the area indicating or denoting the bounding regions. The map may be generated using the image data or on any other data representing the area shown in the image data, such as a georeferenced version of the image data.

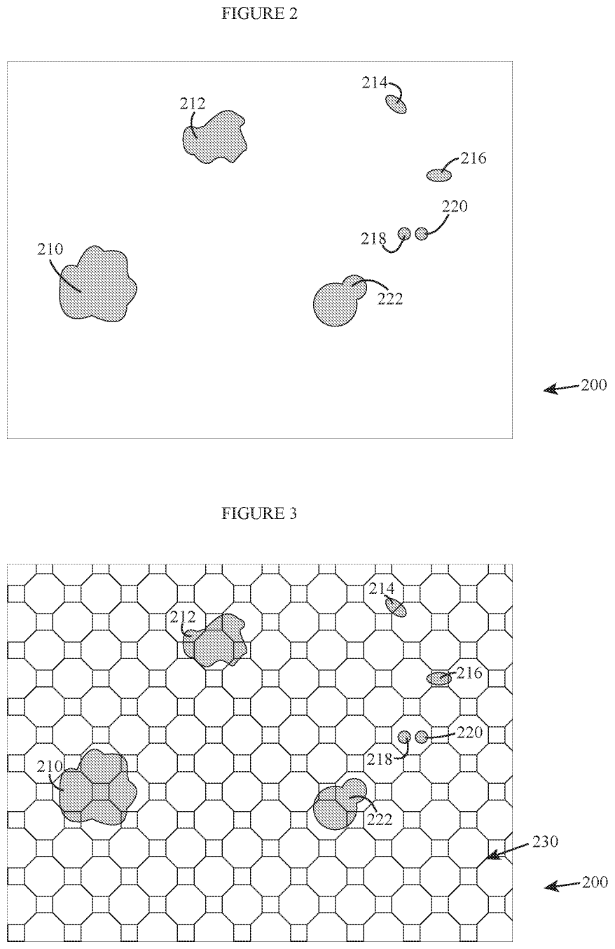

An example application of the process of forming and manipulating bounding regions according to steps 140 to 160 of method 100 is described next with reference to FIGS. 2 to 8.

FIG. 2 shows example image data 200 of an area including multiple objects 210, 212, 214, 216, 218, 220, and 222, which may have been detected through an image segmentation process as described above.

FIG. 3 shows image data 200 partitioned into a first layer 230 of regions in the shape of regular octagons. An octagon is an example of a non-tessellating shape, or a shape that does not form a tessellation, because octagons that are fitted together without overlapping form gaps between each other. The octagonal regions of layer 230 are arranged in a contiguous array, so that adjacent regions share a common border or side, and the gaps formed between the regions are in the shape of squares. The partitioning is done by overlaying image data 200 with layer 230, but it is to be understood that other ways of partitioning image data 200 may be used.

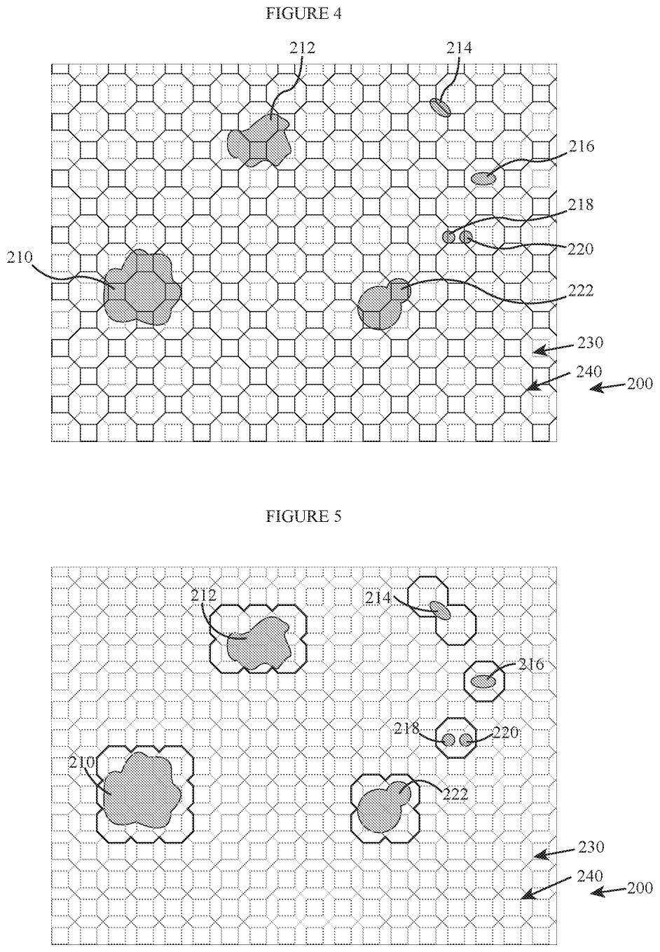

FIG. 4 shows image data 200 further partitioned into a second layer 240 of regions, overlapping layer 230. The regions of layer 240 have the same shape, size, and arrangement as the regions of layer 230, but are offset relative to the regions of layer 230 so that each region of layer 240 confines and is centred about a gap in layer 230 (correspondingly, each region of layer 230 confines and is centred about a gap in layer 240).

The offset between layers 230 and 240 means that when the quality of fit of the regions of layer 230 to an object is poor, the quality of fit of the regions of layer 240 to the same object is likely to be better, and vice versa. For example, as can be seen in FIG. 3, the regions of layer 230 fit poorly around object 216 because most of the object falls within a gap, and only small portions of the object are contained within octagonal regions. In contrast, object 216 is well-contained within an octagonal region of layer 240, and no part of object 216 falls into a gap in layer 240. Therefore, overlapping, offset layers of regions may facilitate the generation of regions that contain the detected objects, in some examples, at or near the centre of the regions.

In other examples, the amount of offset between overlapping layers may be such that the gaps in one layer are contained, but not necessarily centred, within the regions of the other layer.

FIG. 5 shows example bounding regions 250, 252, 254, 256, 258, and 262 formed from the regions of layers 230 and 240 determined to best fit each of the objects.

Bounding regions 250, 252, 254, and 262 comprise multiple regions of layer 230 or of layer 240 so that the outline of each of these bounding regions is formed from at least part of the outlines of multiple regions of layers 230 and 240. In contrast, bounding regions 256 and 258 are each formed by or correspond to a single region of layer 230 or of layer 240.

Each bounding region encloses a single object, except for bounding region 258, which encloses both of objects 218 and 220 since the same bounding region provides a fit which meets the minimum fit criteria for each one of objects 218 and 220. In other examples, when different fit criteria are used, objects 218 and 220 may be represented by separate bounding regions.

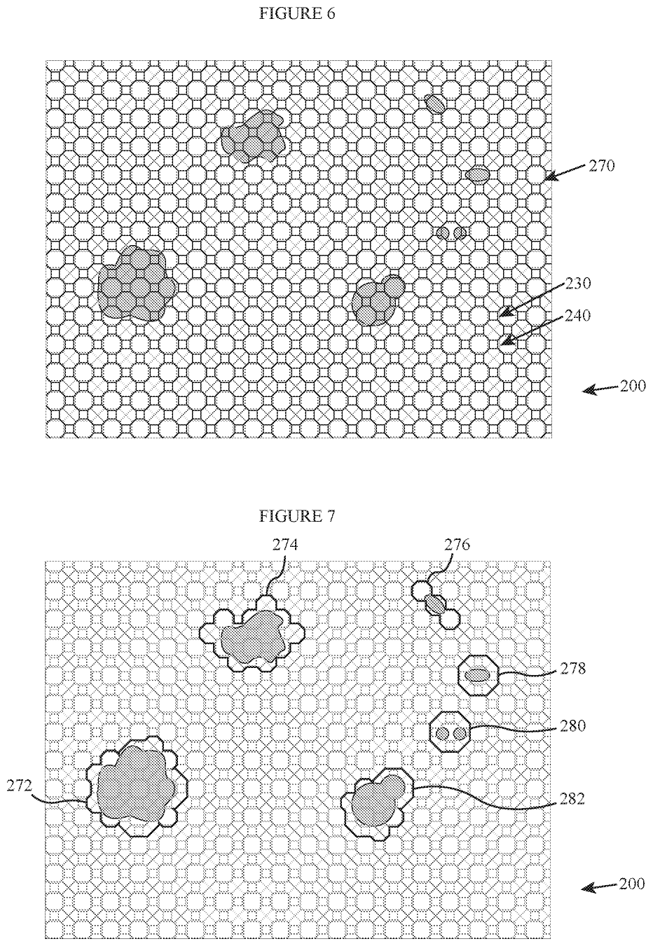

FIG. 6 shows image data 200 further partitioned into a third layer 270 of regions in the shape of regular octagons which are smaller than the regions of layers 230 and 240. The regions of layer 270 are sized and positioned to overlap and be centred about the gaps in layers 230 and 240.

FIG. 7 shows example bounding regions 272, 274, 276, 278, 280, and 282 formed from the regions of layers 230, 240, and 270 determined to best fit each of the objects. It can be seen that the bounding regions in FIG. 7 generally provide a better fit than the bounding regions in FIG. 5 since they more closely conform to the shapes of the objects. The improved fit is due to the smaller size of the regions of layer 270.

The size of the regions of each layer may affect the resolution of the bounding regions formed around the detected objects, or the degree of conformance of those boundaries to those objects. The size of the regions of each layer may also affect the location or centring of the detected objects within the bounding regions formed around them. A smaller region size generally produces bounding regions with higher resolution and improved centring, but, since smaller regions may impose a greater computational load, layers with smaller regions may in some examples only be applied to certain portions of the image data containing objects that are small or sharply shaped, or to any other portion of the image data requiring bounding regions to be generated with a higher level of precision or resolution. For example, fruit on a tree may require a higher mapping resolution than a weed in a field.

The size and shape of the regions may depend on one or more of the size and shape of the predetermined objects, the size of a buffer zone, and a sensitivity or resolution level parameter. In some examples, the size of the largest regions corresponds to the size of the predetermined objects. In some examples, additional layers of regions with diminishing size are used to partition the image data (or a portion of the image data) if one of the detected objects is located near an edge of a region, and/or if one of the detected objects fills or covers less than a minimum portion of a region. In some examples, the minimum portion is 60 percent of the region. In other examples, the minimum portion is greater than 60 percent.

Certain bounding regions, such as bounding regions 272 and 282, comprise regions of multiple layers, so that one or more parts of their outlines correspond to the outlines of small octagonal regions belonging to layer 270 and one or more parts of their outlines correspond to the outlines of large octagonal regions belonging to layer 230 or 240.

In the examples shown in FIGS. 5 and 7, each bounding region is the smallest area defined by the perimeters, or parts of the perimeters, of the regions of layers 230, 240, or 270 that encloses or contours each object, so that each bounding region is formed from a collection of regions that best conforms or matches the shape of an object. However, in other examples, different definitions of the quality of fit may be used to generate different bounding regions for each object. For example, a bounding region may be formed from any one or more regions that contain the elements of the image data representing an object at or near their centres.

Although bounding regions 272, 274, 276, 278, 280, and 282 are determined from the partitioning of the image data into three layers of regions, in other examples, bounding regions may be determined from the partitioning of the image data into pairs of layers, where the layers in each pair comprise regions of the same shape and size that are offset relative to each other, like layers 230 and 240, to facilitate finding the best-fitting regions, as explained above. Therefore, in other examples, image data 200 may be further partitioned into a fourth layer comprising octagonal regions of the same size as, but offset to, the regions of layer 270 before bounding regions 272, 274, 276, 278, 280, and 282 are determined.

In some examples, method 100 further comprises a step of enlarging or expanding the bounding regions to provide a buffer zone or margin around the predetermined objects fitted by the bounding regions, ensuring that the predetermined objects, and especially objects located near the edge of a boundary, are fully contained and, in some examples, centred within the bounding regions. A buffer zone may be provided either by enlarging a bounding region or by enlarging regions of the layers before the bounding region is formed. The size of the buffer zones may be specified by the user or generated automatically.

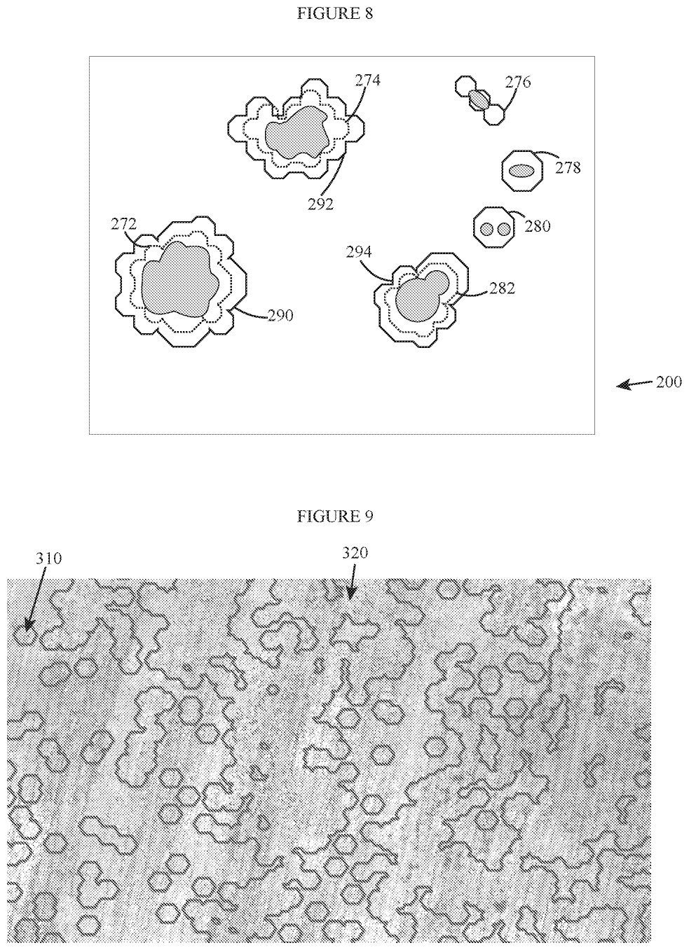

FIG. 8 shows example buffer zones formed around objects 210, 212, and 222 by expanding bounding regions 272, 274, and 282 to form expanded bounding regions 290, 292, and 294, respectively.

In some examples, method 100 further comprises a step of categorising or classifying each of the one or more bounding regions (or the regions forming each bounding region) based on characteristics, features, or attributes of the predetermined objects contained in each bounding region.

The bounding regions may be categorised into any number of classes, such as two, three, or more. The classes may be defined based on one or more features of the predetermined objects. In some examples, the features are physical features, such as size, height, shape, or colour. In other examples, the features are chemical features, such as light reflectance, water content, macronutrient content [including a concentration of, for example, nitrogen (N), phosphorus (P), potassium (K), magnesium (Mg), calcium (Ca), and sulfur(S)], or micronutrient content [e.g. including a concentration of sodium (Na), iron (Fe), manganese (Mn), boron (B), copper (Cu), and zinc (Zn)]. For example, each bounding region may be categorised into one of three classes, comprising a first class for regions containing objects of a predetermined large size, a second class for regions containing objects of a predetermined small size, and a third class for regions containing no objects. The size of an object may be determined by the number of elements of the image data, such as the pixels, that form the object.

Categorising the bounding regions may comprise performing a mathematical analysis, such as a statistical analysis using zonal statistics, of the values assigned to the elements of the image data contained in each bounding region. In some examples, the statistical analysis is a sum of the values. For example, when pixels determined to represent the predetermined objects are assigned a value of one and other pixels are assigned a value of zero, the size of a predetermined object in a particular region may depend on the sum of the values assigned to the pixels representing that object. The mathematical analysis may be performed for each region forming a bounding region so that, when a bounding region is formed from multiple overlapping regions, elements of the image data that are contained in two or more overlapping regions may undergo multiple analyses, reducing the possibility that an object located at the edge of one region may be missed, or that an object located at the boundary between multiple regions may be mischaracterised as two or more smaller objects, as may happen when, for example, a weed 30 cm in diameter lying between two regions in the same layer is erroneously classified as two separates weeds with 15 cm diameters. Regions that are in the shape of octagons may be better suited to such a mathematical analysis than square regions because they have more points of reference and can be further divided into more triangles, which form the basis of several kinds of mathematical analysis.

In some examples, method 100 further comprises a step of identifying one or more “unoccupied” regions. An unoccupied region is a region for which a quantity representing or calculated based on the values assigned to the elements of the image data contained in the region is below a minimum threshold value or object threshold value. The quantity representing the values of the elements of the image data contained in the region may be a zonal statistic for the region. An unoccupied region may therefore be a region that does not contain a predetermined object, or that contains an object deemed insignificant or unimportant, such as a very small weed. The unoccupied regions may be categorised in one of the plurality of classes, as in a class of unoccupied regions. The minimum threshold value may be set or changed based on a desired sensitivity for the mapping process.

In some examples, two or more bounding regions categorised in the same class are aggregated into a single bounding region if they are adjacent or if they overlap, as may be the case when the two or more regions belong to different layers of regions. The boundary or limits of aggregated bounding regions may correspond to the boundary of the union of the two or more aggregated bounding regions. For example, the boundary of a bounding region that is not adjacent, contiguous, or overlapped by any other region in the same class is the boundary of the region itself, such as boundary 310 of a single hexagonal region shown in FIG. 9. For comparison, the boundary of a group or cluster of bounding regions comprising two or more bounding regions that are in the same class and that are adjacent or contiguous or that overlap is the boundary of the aggregate of the two or more regions, or the outermost boundary of the group of bounding regions, such as boundary 320 of multiple hexagonal regions shown in FIG. 9. Therefore, the boundary of the aggregate of two or more adjacent, contiguous, or overlapping bounding regions in the same class may be determined by “dissolving” or “melting” the boundaries or contours of the individual bounding regions that define adjacent or overlapping bounding regions to form a single, larger boundary.

In some examples, method 100 further comprises a step of forming one or more supra- or compound bounding regions, each of which at least partially encloses two or more bounding regions. The region data outputted may further represent the compound bounding regions. In some examples, data representing a compound bounding region replaces and is outputted instead of data representing the two or more bounding regions enclosed by compound bounding region.

Example compound bounding regions are shown in FIG. 13, in which multiple separate bounding regions 370 enclose different objects 360, and in which separate compound bounding regions 380 each enclose multiple bounding regions 370. Compound bounding regions 380 are generally more smooth (or less jagged) than regions 370 which they enclose. The formation of compound bounding regions may therefore simplify, or reduce the number of edges, gaps, and discontinuities, in the areas bound by bounding regions. Additional compound bounding regions may then be formed around regions 380, further simplifying or smoothing the bounding regions. This simplification process may, in some examples, benefit from the octagonal shape of the regions forming bounding regions 370 because octagons have more points than polygons with fewer sides, and these additional points allow for greater flexibility in the smoothing process. Octagonal regions may therefore allow for improved analytics and help to produce compressed files that better represent and align with the area in question.

The values assigned to the elements of the image data contained in two or more regions, or the zonal statistics calculated based on those values, may be combined when those two or more regions are aggregated, to provide one quantity for each set of regions that are aggregated together, or for the predetermined object fitted by those aggregated regions. The combined values or zonal statistics may then be used to categorise the regions fitted to the predetermined object.

In some examples, method 100 further comprises a step of smoothing the boundaries of the bounding regions. In some examples, method 100 further comprises a step of collecting the bounding regions categorised in the same class into a data type or entity. There may be as many entities as there are classes, each entity comprising the bounding regions categorised in a particular class. An entity may be a feature layer defined by the particular or defining feature of a class. In some examples, the entities are output separately, so that a user can analyse the mapping of the objects in each single class separately. In other examples, the entities are merged and output together.

In some examples, method 100 further comprises a step of receiving terrain or elevation data, such as a digital elevation model (DEM) or a digital terrain model (DTM), of the area or of part of the area. Method 100 may further comprise a step of identifying regions of rough terrain, where elevation variations in the area exceed an elevation variation threshold based on the elevation data. Regions of rough terrain may be regions where the elevation deviates from the mean elevation profile of those regions by a predefined amount. Method 100 may further comprise a step of enlarging the identified regions to provide a buffer zone or margin around objects detected in those regions. Providing a buffer zone around regions of rough terrain such as contour banks and washout areas may, for example, facilitate the application of chemicals by boom sprayers and reduce the probability of patches within those regions being missed.

In some examples, method 100 further comprises outputting action data or an action parameter associated with each bounding region based on its class. An action parameter may be a value or other representation or descriptor of an action that is set or assigned to each class. For example, in agricultural contexts, the action parameter may be an application rate for a product, such as a chemical or seeds, to be applied to the regions based the size of plants contained within them. The application rate may be set to 100 for regions containing large plants, 50 for regions containing small plants, and 0 for regions containing no plants (although the application rate for regions containing no plants may be set to a non-zero value if a “blanket” application of the product is desired). In some examples, the application rate is set by the user. In other examples, the application rate is pre-set, and the user may set a multiplier to be applied to each pre-set value to adjust the application rate (e.g. a multiplier of 1.5 changes a pre-set application rate value from 100 to 150).

In some examples, method 100 further comprises outputting one or more features or variables associated with the area defined by one or more bounding regions encompassing or overlying that area. For example, in agricultural contexts, a feature may represent the number of past applications of herbicide in a region, to allow for tracking of the resistance of plants in that region to herbicide. In some examples, bounding regions are categorised based, at least in part, on historical features associated with the regions, such as during a past iteration of method 100. For example, if a bounding region has been categorised as containing large weeds in the past, it may continue to be categorised as containing large weeds until weeds are no longer detected in that area a specified number of times.

In some examples, the categorised regions and, where applicable, the action parameter, are output as a single file. In some examples, the file is a machine control file, such as a shapefile, JSON file, or XML file, which can be loaded or provided to the controller of an apparatus for action. In some examples, the file is cropped to remove locations where the operation of the apparatus should be avoided, such as near a tree line. Where regions belonging to different classes have been split into different entities, the regions belonging to different entities may be merged to create a single entity prior to being output.

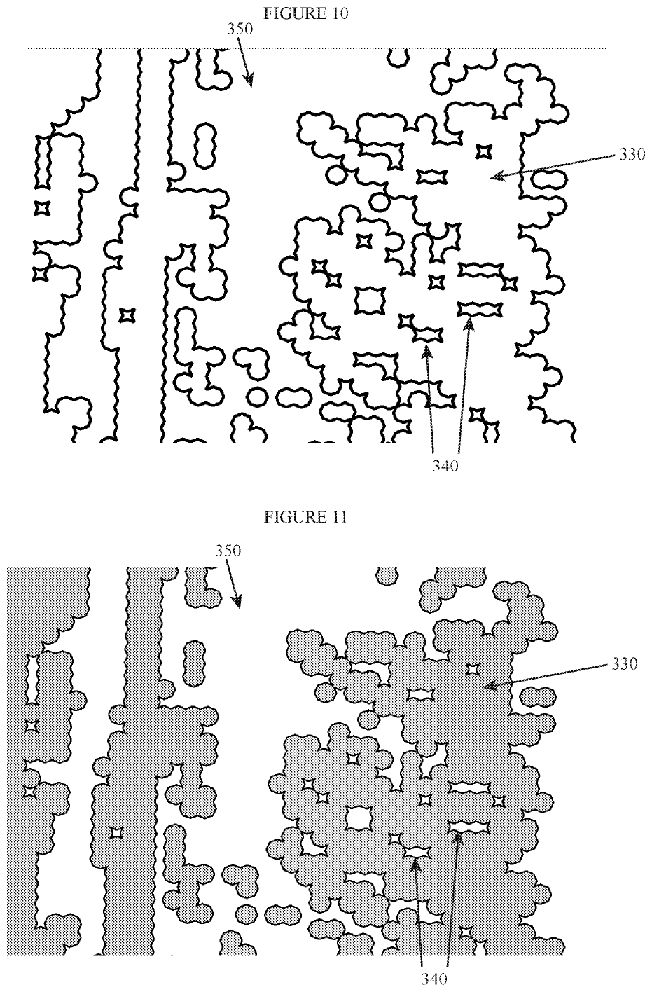

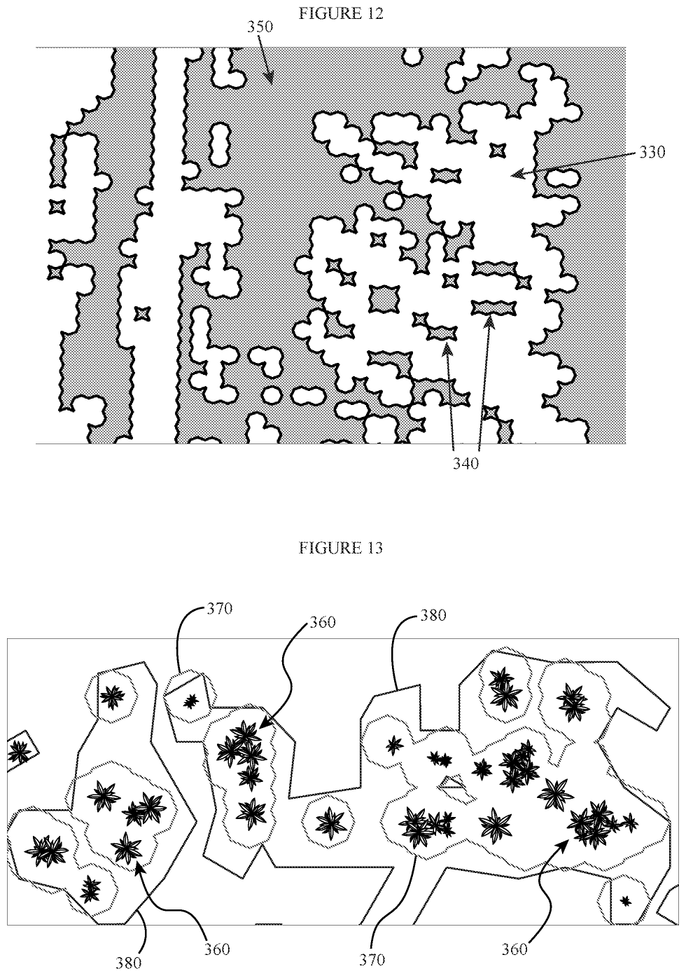

FIGS. 10 to 12 show examples of maps that may be outputted, such as in the form of a shapefile or a JSON string, showing an area and regions categorised in a particular class. The maps include a complex region 330, formed by aggregating multiple octagonal, adjacent or overlapping regions in the same class. Gaps 340 within region 330 represent parts of the area that do not contain the same category of object as region 330 (e.g. gaps 340 may correspond to unoccupied regions). The maps also include an unoccupied area 350, which does not include any predetermined object or which includes negligible predetermined objects. Complex region 330 may be marked for the application of a product, such as herbicide, denoted by the shading of this region in FIG. 11. Alternatively, gaps 340 and area 350 may be marked for the application of a product, denoted by the shading of these areas in FIG. 12.

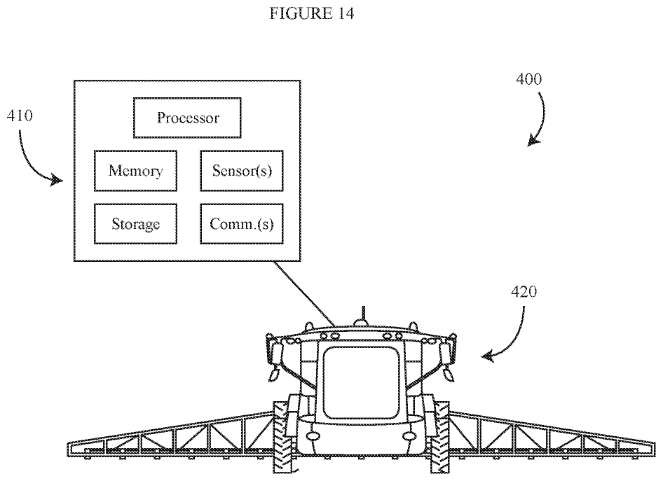

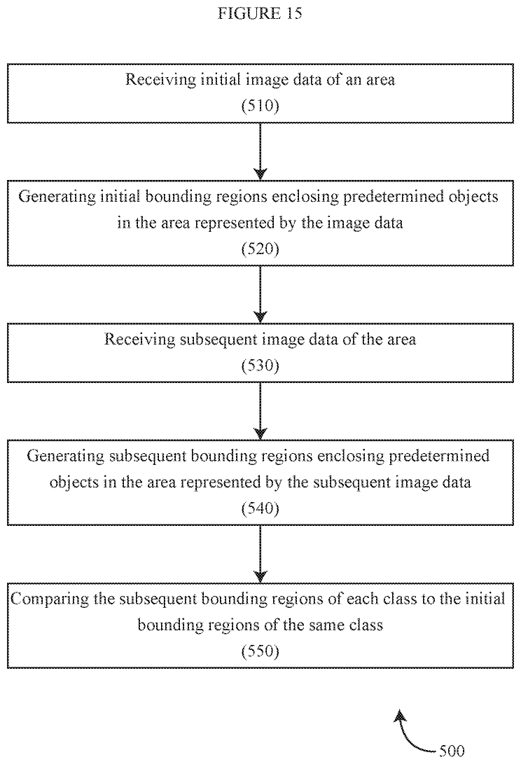

FIG. 14 shows an example system 400 for mapping objects. System 400 comprises at least one processing system 410 and an apparatus 420 communicatively coupled to processing system 410.

Processing system 410 is configured to perform or implement method 100 and any other step described herein.

Apparatus 420 is an agricultural sprayer configured to spray a chemical with an adjustable spray rate or volume. In other examples, apparatus 420 may be any kind of physical system or machine configured to affect or perform one or more actions in the area based on the data provided by processing system 410. Apparatus 420 may operate under user control or autonomously (i.e. without or with limited user input), solely based on the data provided by processing system 410. Apparatus 420 is configured to receive or obtain from processing system 410 data of the bounding regions and, in some examples, an action parameter associated with each bounding region, and to affect one or more bounding regions in the area based on the corresponding action parameters.

Apparatus 420 may receive the data from processing system 410 through any communication channel, wireless or wired, including through the Internet. In other examples, apparatus 420 is not communicatively coupled to processing system 410, in which case apparatus 420 may be configured to receive the data from processing system 410 indirectly, such as through a USB flash drive or any other data storage system.

In some examples, processing system 410 comprises a back end configured to process jobs from a queue and send the results back via the queue for processing by a front end system. The back end involves virtual environments on a server which run each task described below in their own respective virtual servers or containers. One virtual server may be an automation server for task management and job reporting, running Continuous Delivery (CD)/Continuous Integration (CI) software. Another virtual server may run a first script (Script 1) which checks for new messages in a queue (i.e. jobs), downloads message details (including a zip file or an array of multi-part files and job requirements), and initiates a second script (Script 2), which initiates a third script (Script 3) and then passes the results back to Script 1, which, in the event of success, uploads the results to a front end storage device, such as S3, via the message queueing system, and, in the event of failure, puts the job into a “retry” state and tries again.

Script 2 performs photogrammetry, including stitching of orthophotos. When Script 2 is complete, Script 3 is initiated.

Script 3 performs object analysis of orthophotos using an image segmentation process, such as a TensorFlow convolutional neural network model or any other one or combination of machine learning or deep learning models, to assign each pixel a value of either one or zero (i.e. “object” or “not an object”), returns a “raster mask” with all pixels that have a non-zero likelihood of representing an object, splits the “raster mask” (pixels values) into a chunked array using “Numpy” and “GDAL”, applies filters according to sensitivity to create a new “raster mask” containing identified objects, and identifies the centre of each object and draws a polygon.

A feature in the attribute table may need to be assigned a value in order to control the variable application rate. To do this, Script 3 removes shapes containing objects below a first threshold, identifies objects above the first threshold and below a second threshold range and assigns these shapes a first “feature” (value 0-100), and identifies objects above the second threshold and assigns these shapes a second “feature” (value 0-100). Script 3 also creates a shape for all areas that are “not an object”, assigns this shape as a feature (0-100), and saves the results to a file or database. Once Script 3 ends, control is returned to Script 1 with the output from Script 3.

Processing system 410 further comprises a front end for user management, uploading images, creating new jobs, and sending or displaying the job results to users. The front end is also responsible for handling all API integrations both into the system from third parties as well as external integrations with machine manufacturers and farm management system providers to assist with machine control and adaptability.

The front end may generate a web page using, for example, NodeJS and RESTful API; it may display applications, manage databases, and perform SQS messaging using, for example, AWS serverless and LAMBDA; it may pass jobs as messages between the front end and the back end using, for example, AWS “Simple Queue Service” (SQS); and it may send messages including a job identifier, images, and details for the job (e.g. weed map with a 5 m buffer, sensitivity 1+elevation map) using, for example, AWS SQS. After the job is processed on the back end, the front end may receive a response message from the back end servers using, for example, AWS SQS. The response message may include the job identifier, the output file, metadata with a link to view the map, and statistics of the map (e.g. weed coverage percentage). The front end may then add the job results to a database (e.g. DynamoDB) using, for example, a LAMBDA function.

The methods for mapping objects described herein may be applied to process image data of an area at different points in time to facilitate comparisons of images of the same area at different times, which may in turn allow for the detection of changes in the objects in the area over time, for example, due to any natural or artificial process.

FIG. 15 shows a flowchart of an example method 500 for detecting changes in objects. Method 500 may be a computer-implemented method, executed by one or more processing systems. In some examples, method 500 is performed by system 400, so that system 400 may further be considered a system for detecting changes in objects.

Step 510 of method 500 comprises receiving or obtaining initial or first image data of an area. The initial image data may represent the area at a first time or period.

Step 520 of method 500 comprises determining or generating initial or first bounding regions enclosing or fitted to one or more predetermined objects in the area represented by the initial image data. The initial bounding regions are categorised into classes based on characteristics of the predetermined objects enclosed or fitted by the initial regions.

Step 530 of method 500 comprises obtaining subsequent or second image data of the area. The subsequent image data may represent the area at a second time or period after the first time or period, so that the subsequent image data provides a later or more recent representation of the area than the initial image data.

Step 540 of method 500 comprises determining or generating subsequent or second bounding regions enclosing or fitted to one or more predetermined objects in the area represented by the subsequent image data. The subsequent bounding regions are categorised into the same classes as the initial bounding regions based on characteristics of the predetermined objects enclosed or fitted by the subsequent regions.

Steps 520 and 540 may comprise the steps of the methods for mapping objects as described herein, such as method 100, applied to the initial image data and the subsequent image data, respectively.

In some examples, method 500 further comprises generating an initial map and/or a subsequent map of the area indicating or denoting the respective initial and/or subsequent bounding regions. The maps may be generated using the respective initial and/or subsequent image data of the area. The initial and subsequent bounding regions and/or maps may be generated with the same settings (e.g. same classes of features, same buffer zone, same image segmentation sensitivity).

Step 550 of method 500 comprises comparing the subsequent bounding regions of each class to the initial bounding regions of the same class.

In some examples, comparing the bounding regions comprises determining locations contained in initial bounding regions and in subsequent bounding regions categorised in different classes, so that the categorisation of those locations changes between the first and second time or period. In other examples, comparing the bounding regions comprises determining numerical or statistical measures of the initial and subsequent bounding regions. In some examples, the numerical measures comprise, for each class, the size or coverage of the initial and subsequent bounding regions in the respective class (i.e. total area or coverage), an increase in the size or coverage of subsequent bounding regions relative to the initial bounding regions in the respective class (i.e. new area or coverage), and/or a decrease in the size or coverage of subsequent bounding regions relative to the initial bounding regions in the respective class (i.e. lost area or coverage).

Method 500 may be used to assess the effectiveness of a treatment, which may be any action, series of actions, or process intended to affect the area or the objects, or a subset of the objects, in the area. In some examples, the treatment is a treatment to control the spread of objects, such as weeds, in the area. In some examples, the treatment is an application of a product to the area. In some examples, the product applied is a chemical or substance, such as herbicide, pesticide, fungicide, or fertiliser. In other examples, the product is seeds. The initial image data may represent the area before the treatment is performed in the area, while the subsequent image data may represent the area after the treatment is performed in the area.

In some examples, prior to step 530, method 500 further comprises a step of performing an initial treatment based on the initial bounding regions. In some examples, after step 550, method 500 further comprises a step of performing a subsequent treatment based on the subsequent bounding regions. The subsequent treatment may also be performed based on the region comparison from the initial treatment, data of the initial treatment, and/or environmental data. Performing a treatment may comprise providing the relevant initial or subsequent bounding regions and an action parameter associated with each initial or subsequent bounding region to an apparatus configured to perform an action in the parts of the area corresponding to the bounding regions based on the action parameters associated with those regions.

For example, a treatment may comprise the application of herbicide to bounding regions in the area based on the size of weeds contained in each bounding region, where bounding regions containing large weeds are sprayed at a rate of 100 L/ha, bounding regions containing small weeds are sprayed at a rate of 50 L/ha, and bounding regions containing no weeds are sprayed at a rate of 0 L/ha (i.e. not sprayed). Numerical comparisons of the bounding regions before and after the treatment may be made for each class, such as for bounding regions containing no weeds, bounding regions containing small weeds, and bounding regions containing large weeds. The effectiveness of the herbicide application may then be assessed using these numerical comparisons.

The standard or threshold for determining whether a treatment was successful may depend on the type of treatment. For example, when the treatment is the application of herbicide, the treatment might be deemed a success if the area of regions containing weeds reduces by 95 percent following the herbicide application, indicating that 95 percent of weeds have been killed.

In some examples, method 600 further comprises a step of receiving or obtaining treatment-related data describing the performance of the treatment. The treatment-related data may be obtained from the apparatus configured to perform the treatment and/or from sensors collecting data for the area. The treatment-related data may comprise environmental data, such as weather data, and data related to the apparatus, such as location data of the apparatus. For example, the treatment-related data may show that herbicide was applied in high-wind or high-temperature conditions, or it may show where the herbicide was applied. The treatment-related data may also be used in assessing the effectiveness of the treatment.

The treatment-related data and/or the higher resolution image data may also be used to detect objects that might have been missed by the image segmentation process. When such objects are identified, image data showing those objects may be added to the training data for the image segmentation process.

Therefore, method 500 may be used to detect and measure changes in the amount of coverage of plants in an area, which may be useful for several applications, including harvest readiness analysis following a “dry down” application, where herbicide is used to kill off excess target plants prior to harvest; measuring a time of action for a specific herbicide on specific weed types and sizes; measuring a likelihood of herbicide resistance in any plant (and taking measures to address this before the problem worsens); measuring the most economical buffer sizes for pre- or post-emergence herbicide; measuring seed strike rates and replant decisions; general assessment and comparison of any two similar treatments; and measuring the effects of weather on a treatment. Method 500 may further be used to map crop developments over time and to determine a crop growth stage, a crop growth rate, harvest dates, and damage to crops. Method 500 may further be used in fruit assessment to determine, for example, fruit age, fruit size, and flower number.

In some examples, the initial image data and/or the subsequent image data comprise image data of the area at two or more different resolutions, such as two or more different ground sample distances (GSDs). Bounding regions may be determined for each resolution of the image data, so that when the initial and the subsequent image data comprise both high-resolution image data and low-resolution image data, four sets of bounding regions may be determined. In some examples, the lower resolution image data has a GSD of 3 cm/pixel. In some examples, the higher resolution image data has a GSD of less than 1 cm/pixel, such as 5 mm/pixel. The higher resolution image data may represent part of the area or the whole area.

The higher resolution image data may be considered ground truth or reference image data for performing scientific analysis, for assessing the accuracy of the lower resolution image data, for tuning or adjusting parameters of the treatment, and for tuning or adjusting parameters of the method for mapping objects (e.g. adjusting buffer sizes or the height from which the image data is captured). For example, a map generated from image data at 3 cm/pixel may identify two small weeds with sizes of 6 cm and 9 cm, respectively. A ground truth map generated from image data at 5 mm/pixel may more accurately determine the actual size and shape of the weeds to be 5.2 cm and 10.6 cm, respectively. Following application of herbicide, the ground truth map may be used to determine that weeds smaller than 7 cm have been killed, but only 50 percent of weeds larger than 9 cm have been killed. This data may be used to adjust, for example, the flight height for capturing the image data, the map sensitivity, or the herbicide application rates to be used for the next treatment.

The term “processing system” may refer to any electronic processing device or system, or computing device or system, or combination thereof (e.g. computers, web servers, smart phones, laptops, microcontrollers, etc.), and may include a cloud computing system. The processing system may also be a distributed system. In general, processing/computing systems may include one or more processors (e.g. CPUs, GPUs), memory componentry, and an input/output interface connected by at least one bus. They may further include input/output devices (e.g. keyboard, displays, etc.). It will also be appreciated that processing/computing systems are typically configured to execute instructions and process data stored in memory (i.e. they are programmable via software to perform operations on data).

Optional embodiments may also be said to broadly include the parts, elements, steps and/or features referred to or indicated herein, individually or in any combination of two or more of the parts, elements, steps and/or features, and where specific integers are mentioned which have known equivalents in the art to which the invention relates, such known equivalents are deemed to be incorporated herein as if individually set forth.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1. A computer-implemented method for mapping objects, the method comprising:
receiving image data of an area;
applying an image segmentation process to the image data to identify one or more elements of the image data determined to have a likelihood of representing one or more predetermined objects in the area;
assigning a value to each element of the image data based on the determined likelihood of the element representing the one or more predetermined objects;
partitioning the image data into two or more overlapping layers of regions;
determining a quality of fit of one or more regions of each layer of the two or more layers to each of the one or more predetermined objects using the values assigned to the elements of the image data;
forming one or more bounding regions from one or more regions of one or more layers of the two or more layers based on the quality of fit of the respective one or more regions, wherein each bounding region encloses one or more of the one or more predetermined objects; and
outputting region data representing the one or more bounding regions.

2. The method of claim 1, wherein partitioning the image data comprises sequentially partitioning the image data into each layer of the two or more layers of regions until the quality of fit of one or more regions of the layers partitioning the image data to each of the one or more predetermined objects meets one or more fit criteria.

3. The method of claim 2, wherein the one or more fit criteria comprise a criterion that the elements of the image data representing the predetermined object fill at least a minimum portion of each region of at least one layer of the two or more layers that contains at least one of the elements of the image data representing the predetermined object.

4. The method of claim 2, wherein the one or more fit criteria comprise a criterion that the elements of the image data representing the predetermined object do not extend into a gap between regions of at least one layer of the two or more layers that is not contained in one or more regions of another layer of the two or more layers.

5. The method of claim 4, wherein determining a quality of fit comprises determining that elements of the image data representing one of the one or more predetermined objects are contained within a gap of a first layer of the two or more layers, and wherein the bounding region enclosing the respective predetermined object is formed from a region of a second layer of the two or more layers that encloses the respective gap of the first layer.

6. The method of claim 1, wherein the regions of each layer of the two or more layers differ from the regions of other layers of the two or more layers in at least one of shape, size, and offset.

7. The method of claim 1, wherein the regions of each layer of the two or more layers are arranged in an array and have non-tessellating shapes.

8. The method of claim 7, wherein the two or more layers comprise one or more pairs of layers, wherein the regions of the layers in each pair are offset such that the regions of a first layer of the pair enclose gaps between regions of a second layer of the pair, and wherein partitioning the image data comprises sequentially partitioning the image data into each pair of the one or more pairs of layers of regions until the quality of fit of one or more regions of the layers partitioning the image data to each of the one or more predetermined objects meets one or more fit criteria.

9. (canceled)

10. The method of claim 1, further comprising categorising each of the one or more bounding regions into one of a plurality of classes based on characteristics of the one or more predetermined objects enclosed by the respective bounding region.

11. The method of claim 10, further comprising:
identifying one or more unoccupied regions, being regions of the two or more layers for which a quantity representing the values assigned to the elements of the image data contained therein is below a minimum threshold value; and
categorising the one or more unoccupied regions into one of the plurality of classes.

12. The method of claim 10, further comprising aggregating adjacent or overlapping bounding regions that are categorised in the same class into a single region prior to outputting the region data.

13. (canceled)

14. (canceled)

15. The method of claim 10, further comprising outputting an action parameter for each bounding region based on the class of the respective bounding region.

16. The method of claim 15, further comprising providing the region data and the action parameter for each bounding region to an apparatus configured to affect the locations of the area represented by each bounding region based on the corresponding action parameter for that bounding region.

17. The method of claim 1, further comprising enlarging one or more of the bounding regions to provide a buffer zone around the one or more predetermined objects enclosed therein.

18. (canceled)

19. (canceled)

20. (canceled)

21. A system for mapping objects, the system comprising at least one processing system configured to:
receive image data of an area;
apply an image segmentation process to the image data to identify one or more elements of the image data determined to have a likelihood of representing one or more predetermined objects in the area;
assign a value to each element of the image data based on the determined likelihood of the element representing the one or more predetermined objects;
partition the image data into two or more overlapping layers of regions;
determine a quality of fit of one or more regions of each layer of the two or more layers to each of the one or more predetermined objects using the values assigned to the elements of the image data;
form one or more bounding regions from one or more regions of one or more layers of the two or more layers based on the quality of fit of the respective one or more regions, wherein each bounding region encloses one or more of the one or more predetermined objects; and
output region data representing the one or more bounding regions.

22. The system of claim 21, wherein the at least one processing system is further configured to:
categorise each of the one or more bounding regions into one of a plurality of classes based on characteristics of the one or more predetermined objects enclosed by the respective bounding region; and
output an action parameter for each bounding region based on the class of the respective bounding region.

23. The system of claim 22, further comprising an apparatus configured to receive the region data and the action parameter for each bounding region, and to affect the locations of the area represented by each bounding region based on the corresponding action parameter for that bounding region.

24. A computer-implemented method for detecting changes in objects, the method comprising:
receiving initial image data of the area;
generating initial bounding regions enclosing one or more predetermined objects in the area represented by the initial image data, wherein the initial bounding regions are categorised into classes based on the predetermined objects enclosed by the initial bounding regions;
receiving subsequent image data of the area, wherein the subsequent image data represents the area at a later time than the initial image data;
generating subsequent bounding regions enclosing one or more predetermined objects in the area represented by the subsequent image data, wherein the subsequent bounding regions are categorised into the classes based on the predetermined objects enclosed by the subsequent bounding regions; and
comparing the subsequent bounding regions of each class to the initial bounding regions of the same class;
wherein the initial bounding regions are generated by applying the method of claim 10 to the initial image data; and
wherein the subsequent bounding regions are generated by applying the method of claim 10 to the subsequent image data.

25. The method of claim 24, wherein comparing the subsequent bounding regions of each class to the initial bounding regions for the same class comprises:
determining the locations of the area represented by the initial bounding regions and by the subsequent bounding regions that are categorised in different classes;
determining, for each class, an increase in the coverage of the subsequent bounding regions relative to the initial bounding regions in the same class; and
determining, for each class, a decrease in the coverage of the subsequent bounding regions relative to the initial bounding regions in the same class.

26. (canceled)

27. (canceled)

28. (canceled)

29. (canceled)

30. The method of claim 24, wherein the initial image data comprises initial image data of the area at a first resolution and initial image data of at least part of the area at a second resolution, wherein the subsequent image data comprises subsequent image data of the area at the first resolution and subsequent image data of at least part of the area at the second resolution, wherein the second resolution is higher than the first resolution.

31. (canceled)
